(19) United States
(12) Patent Application Publication
(10) Pub. No.: US 2016/0332799 A1
(43) Pub. Date: Nov. 17, 2016

(54) THERMAL RECEPTACLE WITH PHASE CHANGE MATERIAL

(71) Applicants: J. Bruce Kolowich, Saline, MI (US); Raymond Booska, Melbourne, FL (US)

(72) Inventors: J. Bruce Kolowich, Saline, MI (US); Raymond Booska, Melbourne, FL (US)

(21) Appl. No.: 15/218,485

(22) Filed: Jul. 25, 2016

Related U.S. Application Data
(63) Continuation of application No. 13/835,171, filed on Mar. 15, 2013.
Application No. 13/835,171 is a continuation-in-part of application No. 13/099,888, filed on May 3, 2011, now abandoned.
Application No. 13/099,888 is a continuation of application No. 11/452,569, filed on Jun. 14, 2006, now Pat. No. 7,934,537.
Application No. 11/452,569 is a continuation of application No. 11/258,703, filed on Oct. 26, 2005, now Pat. No. 7,059,387.
Application No. 11/258,703 is a continuation of application No. 10/690,098, filed on Oct. 21, 2003, now Pat. No. 6,968,888.
Application No. 10/690,098 is a continuation of application No. 09/055,377, filed on Apr. 6, 1998, now Pat. No. 6,634,417.
(60) Provisional application No. 60/043,431, filed on Apr. 7, 1997.

(51) Int. Cl. B65D 81/38; A61J 9/00; A47G 19/22

(52) U.S. Cl. CPC B65D 81/3872; A47G 19/2266; A47G 19/2288; B65D 81/3869; B65D 81/3874; A61J 9/00

(57) ABSTRACT

A liquid receptacle has an inner vessel for holding a liquid, an insulated outer shell spaced from the inner vessel, and a chamber defined between the inner vessel and the outer shell. A phase change material is disposed in the chamber for absorbing thermal energy from the liquid and then releasing the thermal energy back to the liquid to maintain the temperature of the liquid.

### CROSS-REFERENCE TO RELATED APPLICATIONS

This application is a continuation of U.S. patent application Ser. No. 13/835,171, filed Mar. 15, 2013, which is a continuation-in-part of U.S. patent application Ser. No. 13/099,888, filed May 3, 2011, which is a continuation of U.S. patent application Ser. No. 11/452,569 filed on Jun. 14, 2006, now U.S. Pat. No. 7,934,537, issued May 3, 2011. U.S. patent application Ser. No. 11/452,569 is a continuation of U.S. patent application Ser. No. 11/258,703 filed on Oct. 26, 2005, now U.S. Pat. No. 7,059,387. U.S. patent application Ser. No. 11/258,703 is a continuation of U.S. patent application Ser. No. 10/690,098 filed on Oct. 21, 2003, now U.S. Pat. No. 6,968,888. U.S. patent application Ser. No. 10/690,098 is a continuation of U.S. patent application Ser. No. 09/055,377 filed on Apr. 6, 1998, now U.S. Pat. No. 6,634,417. U.S. patent application Ser. No. 09/055,377 claims the benefit of U.S. Provisional Application 60/043,431 filed on Apr. 7, 1997. Each patent application identified above is incorporated herein by reference in its entirety to provide continuity of disclosure.

### TECHNICAL FIELD

The subject invention relates generally to liquid receptacles or containers and more specifically to a receptacle that rapidly cools a hot liquid to a warm range and then maintains the fluid in the warm range for an extended period.

### BACKGROUND OF THE INVENTION

There have been many attempts in the past to maintain liquids and solids within certain temperature ranges. Hot beverages are usually prepared and served at temperatures well above the temperature at which consumers prefer to drink them. Typically, the consumer must wait an extended period for the beverage to sufficiently cool before drinking it. Some impatient consumers will attempt to drink the beverage too soon resulting in burns to the mouth. Similarly, if the drink is spilled before it has had sufficient time to cool, burns to the skin may result. Therefore, it is desirable to rapidly cool the beverage from the temperature at which it is served to an acceptable drinking range. Once the beverage is within the acceptable drinking temperature range, it is desirable to maintain the temperature of the beverage within this range for an extended period of time.

Many approaches have been tried for both rapidly cooling a hot beverage and for maintaining the temperature of the beverage within an acceptable drinking temperature range. To rapidly cool a hot beverage, ice or a cool liquid (e.g., water or milk) can be added to the hot beverage. This approach rapidly cools the beverage but dilutes the hot beverage. This is frequently undesirable. This approach is often inconvenient and imprecise; if the person adds too little or too much, the temperature of the hot beverage will be higher or lower than desired and may require further attention. Finally, this approach does not provide any assistance in maintaining the temperature of the hot beverage in the acceptable drinking temperature range. Once the beverage reaches an acceptable temperature, it will continue to lose thermal energy to its surroundings. This results in the beverage becoming cool too quickly. Therefore, the beverage remains within an acceptable drinking temperature range for only a short period.

A hot beverage can also be cooled by pouring it into a cool container. Thermal energy is transferred from the hot beverage to the cool container thereby warming the container and cooling the beverage. This approach suffers from some of the same limitations as adding cool liquid or ice. If the cup is too cool or too warm or has too much or too little thermal mass, the beverage will stabilize at the wrong temperature. Also, while a heavy container will slow the rate of cooling somewhat due to the increase in the total thermal mass of the system, the effect will be small and the beverage will only remain in the ideal drinking range for a short period.

Up to this time, the primary method employed for slowing the cooling rate of a beverage was to insulate the container. Everything from simple foam cups to expensive and sophisticated vacuum mugs is used. These approaches slow the cooling rate of the beverage. However, the ability of the insulated mugs currently on the market to maintain beverage temperatures is relatively limited. Even the best mugs usually keep liquids warm for less than 45 minutes. Stainless, vacuum insulated mugs are best at maintaining temperature, but no product currently exists which can passively cool a hot beverage quickly. Also, the beverage in an insulated container will continue to cool despite the insulation. The cooling rate will only be slowed. Insulation does not provide a way to add thermal energy back to the beverage.

To maintain the temperature of a beverage as it cools, the prior art has taught the use of an electric heater. At least one manufacturer produces a portable refrigerator/heater which plugs into a car's cigarette lighter and may be used to cool or warm beverages. Likewise, plug-in mugs, hot plates and immersion devices may be used to keep beverages warm. Some beverage containers are available that plug into accessory plugs in automobiles. A container may also be periodically microwaved to reheat the contents. All of theses approaches suffer from lack of portability and dependence on outside energy sources. They also fail to address the need to rapidly cool a beverage to an acceptable drinking temperature range.

The demand for hot beverages is very high, especially for coffee and tea, the most popular adult hot beverages. In 1990, approximately 42% of the US population consumed coffee and 30% consumed tea. The number of occasions that hot beverages are consumed away from home has increased significantly in recent years. By 1999, the Specialty Coffee Association of America predicts that there will be approximately 10,000 coffee cafes in comparison to the approximately 3,000 in 1996. The Association forecasts that of the $1.5 billion in sales coffee cafes will ring up in 1999, 20% will be from hot beverage take out.

Therefore, it is desirable to develop a reusable beverage container that will rapidly cool a beverage to an acceptable drinking temperature, will maintain the temperature within an acceptable temperature range for an extended period, requires neither manipulation by the consumer or the input of external energy, and is portable.

Another related application requiring temperature regulation is baby bottles. Beverages given to infants usually must be warmed but it is important to not give an infant a beverage that is too hot. Infants cannot tolerate temperatures as high as adults and parents must learn to determine the maximum acceptable temperature for their child. Therefore, when a beverage is warmed for an infant, it may be necessary to cool it rapidly back to an acceptable temperature. If the beverage is too warm, a parent typically must add cool liquid or allow time to pass. Also, if the infant is fussy and does not drink the entire contents of the bottle immediately, the contents may cool to the point that the infant will not drink it. Then the parent must reheat the bottle being careful to not overheat it. Insulated baby bottles are available which extend the time the contents are acceptably warm but they fail to add thermal energy back to the bottle contents. Therefore, it is desirable to develop a baby bottle that will rapidly reduce the temperature of a beverage to a safe drinking temperature for an infant and then will maintain that temperature for an extended period.

Another application where it is desirable to regulate the temperature of a liquid is in bathing tubs. When a person takes a bath or soaks in a tub, the water must be within a certain range to be comfortable. If the water is too hot, the person may be unable to enter the water or may be injured by it. This is especially important with infants and small children. If the water is too hot, cold water must be added until the temperature falls in an acceptable range. Once the water is at an acceptable temperature, it is desirable to maintain its temperature for the period of the bath. If a person wishes to soak or a child wishes to play in the tub for a period of time, the water may become uncomfortable due to its falling temperature. Then, additional hot water must be added to raise the temperature back into the acceptable range. Insulated bathing tubs are available which help reduce the rate of temperature loss but do not address the issue of water that is too hot. They also fail to add thermal energy back into the tub. Some whirlpool tubs include heaters for maintaining the temperature of the water but these devices are expensive to purchase and operate, require a complex system of pumps, valves and switches, and are noisy in operation. They also fail to address the issue of water that is too hot. Therefore, it is desirable to develop a bathing tub that would rapidly reduce the temperature of water to an acceptable bathing range and then to maintain the temperature of the water within the acceptable range for an extended period.

### SUMMARY OF THE INVENTION

This invention addresses the need to rapidly lower the temperature of a liquid to a warm range suitable for human contact and then maintain the liquid in the warm range for an extended period of time. The invention comprises a liquid receptacle having a side wall with a lower end and an open upper end. A bottom wall closes off the lower end of the side wall. The side wall has an inner surface and a spaced outer surface. An interstitial chamber is defined by the space between the inner and outer surfaces. An insulation layer is disposed at least partially between the chamber and the outer surface of the receptacle. A phase change material at least partially fills the chamber. The phase change material regeneratively absorbs thermal energy from a hot liquid in the receptacle thereby rapidly lowering the temperature of the liquid and then the material releases the thermal energy back to the liquid to maintain the temperature of the liquid.

The present invention provides a number of improved thermal receptacles or accessories utilizing one or more phase change materials. According to one embodiment, a liquid receptacle is provided for rapidly lowering the temperature of a liquid contained therein to a warm range suitable for human contact and maintaining the liquid in the warm range for an extended period. The receptacle has a drinking lip at an uppermost end and a base at a lowermost end. The receptacle includes an inner vessel for holding a liquid, having an open upper end and a closed lower end with a side wall extending therebetween. A first intermediate wall has an upper end and a lower end, and surrounds the inner vessel. It is at least partially spaced from the inner vessel so as to define a first chamber therebetween. An insulated outer shell has an open upper end and a lower end. The insulated outer shell surrounds the first intermediate wall and is at least partially spaced therefrom so as to define a second chamber therebetween. A first phase change material is disposed in the first chamber for regeneratively absorbing thermal energy from the liquid and then releasing the thermal energy to the liquid to maintain the temperature of the liquid.

In some versions, a second phase change material is disposed within the second chamber. This phase change material has a phase change temperature different than the first phase change material. The phase change temperature of the second phase change material may be different than the phase change temperature of the first phase change material.

In some versions, the insulated outer shell includes a second intermediate wall surrounding the first intermediate wall and an outer wall surrounding the second intermediate wall. The outer wall is at least partially spaced from the second intermediate wall so as to define an insulation chamber therebetween. The insulation chamber has a partial vacuum or an insulating material disposed therein. In one approach, the outer wall and the second intermediate wall comprise an outer two wall cup having a closed lower end and an open upper end. The upper end of the outer wall and the upper end of the second intermediate wall are interconnected to define the open upper end of the outer two wall cup. The inner vessel and the first intermediate wall comprise an inner two wall cup having a closed lower end and an open upper end. The upper end of the inner vessel and the upper end of the first intermediate wall are interconnected to define the open upper end of the inner two wall cup. The inner two wall cup is received inside the outer two wall cup to form the liquid receptacle. The inner two wall cup may threadingly engage the outer two wall cup. Alternatively, a lip element may be provided that has an upper part defining the drinking lip of the liquid receptacle and a lower part receiving the upper ends of the inner two wall cup and outer two wall cup. The entire device may alternatively be made as a single unit using blow molding or some other plastic forming process.

In some versions, the inner vessel is formed of metal and the first intermediate wall is formed of thermally conductive plastic, such as a thermally conductive high density polyethylene.

In some versions, the first intermediate wall has a closed bottom spaced from the closed bottom of the inner vessel and the insulated outer shell has a closed bottom spaced from the closed bottom of the first intermediate wall. The inner vessel, first intermediate wall, and insulated outer shell are interconnected adjacent the upper ends of the vessel wall and shell.

Some versions further include a lip element having an upper part defining the drinking lip of the liquid receptacle and a lower part interconnected with the upper ends of the inner vessel, first intermediate wall, and insulated outer shell.

In some embodiments of the present invention, the inner vessel has an inner surface with a plurality of indentations or protrusions defined therein and an outer surface with a plurality of corresponding protrusions or indentations defined thereon such that the effective surface area of the inner and outer surfaces is increased, whereby the heat transfer through the wall of the inner vessel is increased. The wall thickness of the inner vessel may be substantially uniform, including the areas of the indentations and protrusions, or varying wall thicknesses may be utilized.

In some embodiments of the present invention, a metal heat transfer element is disposed in the chamber containing the phase change material, along with the phase change material. The metal heat transfer element may be aluminum wool, a folded fin heat sink, or a mesh of metal or other thermally conductive material.

The present invention also provides an accessory for use with an insulated cup for providing the benefits of a phase change material to the insulated cup. This phase change apparatus is designed to rapidly lower the temperature of a liquid contained in the insulated cup. The apparatus includes a generally tubular housing having an open upper end and an open lower end with a side wall extending therebetween. The side wall has an inner surface and an outer surface and a chamber defined in the side wall. A phase change material is disposed within the chamber for regeneratively absorbing thermal energy from a liquid and then releasing the thermal energy of the liquid to maintain the temperature of the liquid. The upper end of the generally tubular housing is configured to engage an upper end of an insulated cup such that the generally tubular housing extends down into the insulated cup inside the side walls of the insulated cup. A plurality of passages are defined between the inner surface and outer surface of the side wall of the generally tubular housing. The passages are defined near the upper end of the generally tubular housing such that liquid disposed between the outer surface of the generally tubular housing and the side wall of the insulated cup flows through some of the passages when the insulated cup is tilted for drinking. In some versions, the generally tubular housing is tapered such that the upper end has a width greater than a width of the lower end. In some versions, the upper end of the generally tubular housing has a lip element with an upper part defining a drinking lip and a lower part configured to receive an upper edge of the insulated cup.

In another embodiment of the present invention, a liquid receptacle has an inner vessel with an open upper end and a closed lower end with a side wall extending therebetween. The inner vessel has an inner surface and an outer surface. The inner vessel is formed of metal. An insulated outer shell has an open upper end and a closed lower end. The shell has an inner surface. The open upper ends of the inner vessel and the outer shell are interconnected by double rolling the upper end of the inner vessel with the upper end of the outer shell and crimping the double rolled upper ends to form a joined upper end. A chamber is defined between the inner surface of the outer shell and the outer surface of the inner vessel. A phase change material is disposed within the chamber for regeneratively absorbing thermal energy from the liquid and then releasing the thermal energy to the liquid to maintain the temperature of the liquid. In some versions, a lip element is provided having an upper part defining the drinking lip and a lower part receiving the joined upper end of the inner vessel and outer shell.

In some versions, the insulated outer shell comprises a first wall and a second wall each having an open upper end and a closed lower end. The first and second walls are joined at the open upper ends to form the outer shell. An insulation chamber is defined between the first and second walls and the chamber has a vacuum or an insulating material defined therein. In some versions, the first and second walls are formed of plastic. Alternatively, one of the walls may be formed of plastic.

In some versions, the inner vessel has an inner surface with a plurality of indentations defined therein and an outer surface with a plurality of corresponding protrusions defined thereon such that the effective surface area of the inner and outer surfaces is increased, whereby heat transfer through the inner vessel is increased. In further versions, a metal heat transfer element is disposed in the chamber and partially fills the chamber. The metal heat transfer element is selected from the group consisting of a body of aluminum wool, a folded fin heat sink, and a mesh of metal or other thermally conductive material.

The present invention is suitable for any application requiring the rapid lowering of the temperature of a liquid in a container and then the maintenance of the temperature of the liquid for an extended period of time. Among other things, the invention can be applied to drinking mugs or cups, baby bottles, carafes, and bathing tubs.

### BRIEF DESCRIPTION OF THE DRAWINGS

FIG. 1 is a cross sectional view of a drinking receptacle according to the present invention;

FIG. 2 is a graph depicting the temperature of a liquid in the subject drinking receptacle versus time, and showing for comparison purposes the heat loss characteristics of a baseline prior art drinking receptacle;

FIG. 3 is a cross sectional view a foam insulated plastic outer shell for the subject drinking receptacle;

FIG. 4 is a cross sectional view as in FIG. 3 but showing an alternative vacuum insulated stainless steel outer shell for the subject drinking receptacle;

FIG. 5 is a cross-sectional view of another embodiment of a liquid receptacle in accordance with the present invention;

FIG. 6 is a cross-sectional view of a portion of an upper end of the receptacle prior to rolling and crimping;

FIG. 7 is a cross-sectional view of the upper end of FIG. 6 during the crimping process;

FIG. 8 is a cross-sectional view of a portion of a liquid receptacle showing a dimpled inner vessel;

FIG. 9 is a cross-sectional view similar to FIG. 8 showing a waffle-like pattern of indentations;

FIG. 10 is a cross-sectional view of a portion of a liquid receptacle in accordance with the present invention having a folded fin heat sink in the phase change chamber;

FIG. 11 is a cross-sectional view similar to FIG. 10 showing a body of aluminum wool disposed in the phase change chamber;

FIG. 12 is a cross-sectional view similar to FIGS. 10 and 11 showing a metal mesh or a metal or graphite powder disposed in the phase change chamber;

FIG. 13 is a cross-sectional view of a further embodiment of the present invention having at least two chambers;

FIG. 14 is a cross-sectional exploded view of a further embodiment of the present invention having an inner two wall cup and an outer two wall cup interconnected by a lip element;

FIG. 15 is a detailed view of the upper end of the liquid receptacle of FIG. 14 after the inner and outer cups are received by the lip element;

FIG. 16 is a cross-sectional view of a further alternative wherein an inner two wall cup and an outer two wall cup threadingly interconnect;

FIG. 17 is a view of the components of FIG. 116 with the inner cup and outer cup separated;

FIG. 18 is a cross-sectional view of an embodiment of the present invention providing an insert for an insulated cup;

FIG. 19 is a view of the assembly of FIG. 14 tilted for drinking;

FIG. 20 is a cross sectional view of a beverage lid with at least one chamber defined therein;

FIG. 21 is a cross sectional view of a baby bottle which is another alternative embodiment of the present invention;

FIG. 22 is a cross sectional view of a carafe which is a further alternative embodiment of the present invention; and

FIG. 23 is a cross sectional view of a bathing or soaking tub which is a yet further alternative embodiment of the present invention.

### DESCRIPTION OF THE PREFERRED EMBODIMENT

Referring to the Figures, wherein like numerals indicate like or corresponding parts throughout the several views, a liquid receptacle is generally indicated at 10. The receptacle 10 includes a inner vessel 12 with an open upper end 13 and a closed lower end 14 and a wall 16 connecting the upper 13 and lower 14 ends. An insulated outer shell 18 is spaced from the inner vessel 12 defining an interstitial chamber 20 therebetween. Phase change material is disposed within the chamber 20.

Preferably, the inner vessel 12 is either wholly or partially formed of a material having a high thermal conductivity such as aluminum, copper or alloys thereof. Pure aluminum has a thermal conductivity of 237 Watts/meter-degree Kelvin when measured at 300 degrees Kelvin. Most aluminum alloys have a thermal conductivity above 150 Watts/meter-degree Kelvin. Pure copper has a thermal conductivity of 401 Watts/meter-degree Kelvin. Most alloys of copper have thermal conductivities significantly lower than pure copper. It is most preferred that inner vessel be formed from a material having a thermal conductivity above 150 Watts/meter-degree Kelvin. As should be obvious to one skilled in the art, other materials, including gold and silver, meet this requirement. A material with a lower thermal conductivity may also be used but the performance of the invention will be reduced accordingly. The inner vessel 12 may be coated, anodized, or plated in order to improve the appearance, resistance to oxidation, or cleanability of the vessel 12. Alternatively, the vessel 12 may be formed from 2 or more different materials. The closed lower end 14 could be formed from plastic while the wall 16 is formed from coated aluminum. A two material inner vessel 12 may be beneficial for cost, manufacturing, or appearance reasons.

One embodiment of the thermal receptacle 10 has an upper rim outside diameter 24 of about 3.5″, and a bottom outside diameter 26 of about 2.75″. The bottom diameter 26 is small enough for the receptacle 10 to fit into typical vehicle drink holders. Total wall thickness 28 varies from a maximum of about ⅝″ to a minimum of about ⅜″ at the uppermost portion. The receptacle 10 may include a removable lid which selectively closes off the upper end 13 of the inner vessel 12. Alternatively, the lid could sit higher and close off the top of the thermal receptacle 10. The receptacle 10 also includes a plastic removable handle 29. The handle 29 can be removed allowing use of the receptacle 10 in vehicle drink holders.

To use the receptacle 10, a consumer removes the lid and pours a hot beverage or liquid into the inner vessel 12 of the receptacle 10, which is initially at room temperature. Because the inner vessel 12 is formed of a thermally conductive material, the chamber 20 is in thermally conductive communication with the beverage or liquid in the inner vessel 12. The thermally conductive material of the inner vessel 12 begins conducting the thermal energy of the hot beverage or liquid into the chamber 20 where it is absorbed by the phase change material. As the phase change material absorbs the thermal energy, the temperature of the phase change material rises from room temperature to its phase change temperature. Preferably the phase change material will change phases in the range of 110-160 degrees Fahrenheit (the phase change temperature). Most preferably, the phase change temperature will be in the range of 140-155 degrees Fahrenheit if the receptacle is to be used by adults. Preferably, the phase change will be from solid to liquid; a melting. One acceptable phase change material is palmitic acid. Many other phase change materials are also available with acceptable phase change temperatures. One class of phase change materials includes a set of naturally occurring fatty acids (soaps) with melting points in the range of 110.degree. F. to 160.degree. F. These materials are advantageous due to their non-toxic and relatively innocuous characteristics. The performance of these materials is enhanced if they are of relatively high purity (95% or better). Examples are stearic, palmitic, and myristic acids. Other possibilities for the phase change material include heavy alcohols, such as cetyl alcohol. As will be clear to one of skill in the art, many materials are available which can be used as phase change materials. However, to be useful for thermal management, a material must change phases at a temperature close to the temperature range desired to be maintained. Also, it is desirable that the material be non-toxic and be readily available at a reasonable price.

Once the phase change material reaches its melting point, the temperature of the phase change material will no longer rise as the thermal energy is absorbed causing the material to melt (change phases). As the phase change material absorbs thermal energy from the hot beverage, the temperature of the hot beverage will fall. The temperature of the hot beverage will continue to fall until the beverage and the phase change material are in thermal equilibrium; e.g., they are at the same temperature. The quantity of the phase change material is chosen so that during its phase change it can absorb enough thermal energy to cool the hot beverage from the boiling point of water down to within a warm range acceptable for human consumption. Once the hot beverage is cooled to within the warm range, the beverage and the phase change material are at equilibrium and the beverage is drinkable. As the beverage loses thermal energy to the surrounding atmosphere, its temperature will begin to fall below the phase change temperature of the phase change material. At this point, the phase change material will begin to transfer thermal energy back through the inner vessel 12 into the beverage. This thermal energy will maintain the temperature of the hot beverage near the phase change temperature of the phase change material as the phase change material resolidifies. Once the phase change material converts back to the solid phase, its temperature will begin to fall and the beverage temperature will no longer be maintained. Because the phase change material remains at the phase change temperature during the phase change, the beverage will be maintained near the phase change temperature for an extended period.

The warm range acceptable for human contact or consumption varies depending on the application. For adults, the warm range acceptable for consumption of a hot beverage is approximately 120 degrees Fahrenheit to approximately 154 degrees Fahrenheit. Above 154 degrees, hot beverages are too hot for most consumers. Most consumers prefer to start drinking a hot beverage at around 145 degrees Fahrenheit. Below 120 degrees, most consumers find that a beverage has become too cool to be palatable. Obviously, preferences vary so receptacles 10 can be manufactured with a variety of phase change materials to tailor the warm range achieved. Also, a receptacle designed for children's beverages requires a lower warm range and therefore a phase change material with a lower phase change temperature is most desirable.

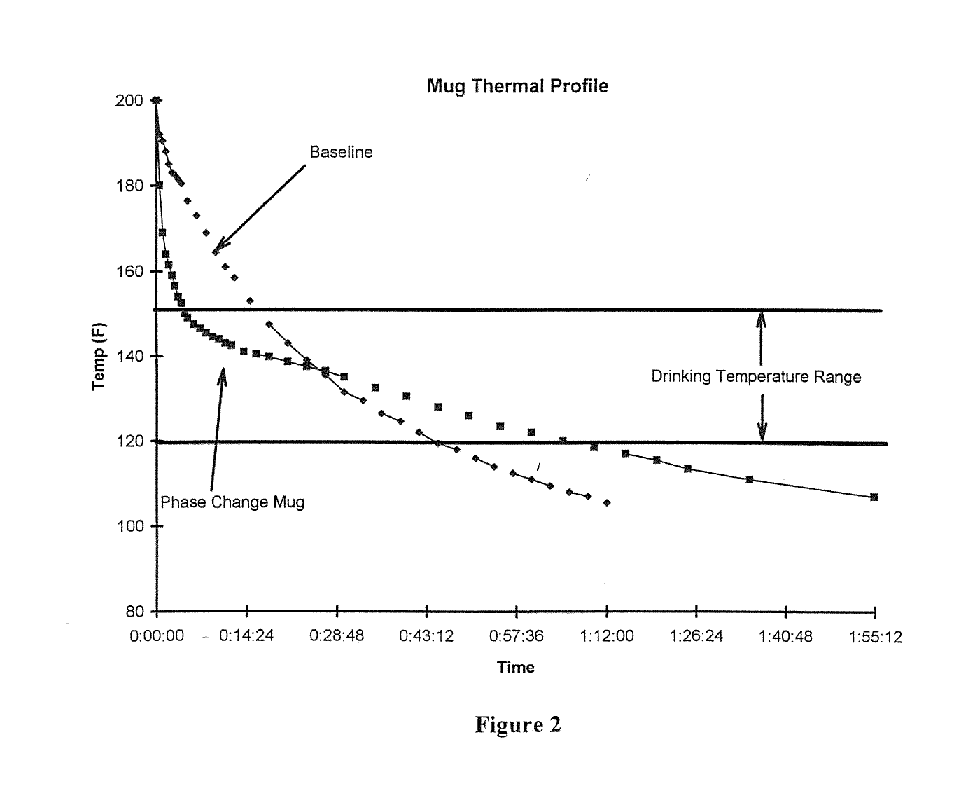

Referring now to FIG. 2, the thermal characteristics of the receptacle 10 adapted for hot beverages for adults are shown. A series of datapoints labeled as baseline indicate the temperature of a hot beverage poured into a typical prior art plastic coffee mug. The temperature of the beverage falls slowly but steadily to the upper limit of the warm range (labeled as Drinking Temperature Range) acceptable for human consumption, which in this example is approximately 150.degree. F. The temperature of the beverage continues to fall at approximately the same rate until it falls below the lower limit of the warm range which in this example is approximately 120.degree. F. Consequently, the beverage is only within the warm range or acceptable drinking temperature range for a short period of time.

The series of datapoints labeled as “Phase Change Mug” illustrate the thermal characteristics of a receptacle constructed according to the present invention. The datapoints indicate the temperature of a hot beverage poured into the receptacle versus time. The beverage cools very rapidly as the thermal energy of the beverage is absorbed by the phase change material. The beverage rapidly falls to the upper limit of the warm range and then the cooling rate slows. The beverage remains within the warm range for an extended period; more than an hour.

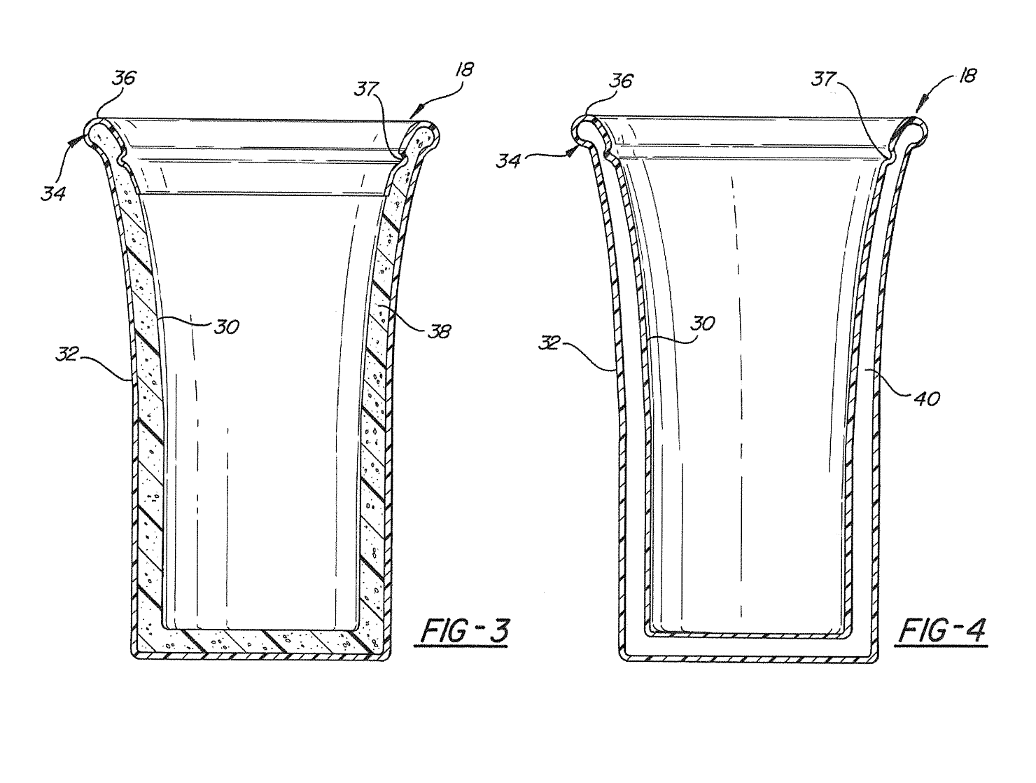

Referring now to FIGS. 3 and 4, the outer shell is shown generally at 18. The shell 18 has an inner surface 30, an outer surface 32, and an upper edge 34 that terminates in a lip 36 for drinking from the receptacle. Two embodiments of the outer shell 18 are envisioned. In the preferred embodiment, shown in FIG. 3, the outer shell 18 has a rigid plastic outer surface 32 and a insulating foam layer 38. The outer surface 32 defines the outer contours of the receptacle 10. The inner surface 30 of the outer shell 18 is defined by the inner surface of the insulating foam layer 38. The insulating foam layer 38 can be made of a variety of insulating foams. Two acceptable foams are polyurethane foam and polystyrene foam.

A first alternative embodiment of the outer shell 18, as shown in FIG. 4, consists of a stainless steel outer surface 32 and inner surface 30 that form a totally sealed chamber 40. The chamber 40 is evacuated thereby creating a vacuum insulated outer shell 18. The two versions of the outer shell 18 have similar shapes but the stainless version is somewhat heavier and more costly to produce. A plastic insulated version of the complete receptacle assembly with a capacity of about 12 fluid ounces has a dry weight of about 12 oz. and the stainless version has a dry weight of about 16 oz.

The performance of the receptacle is greatly enhanced by the insulated outer shell 18. The insulation slows the loss of thermal energy from the phase change material thereby greatly extending the period that the beverage can be maintained within the warm range.

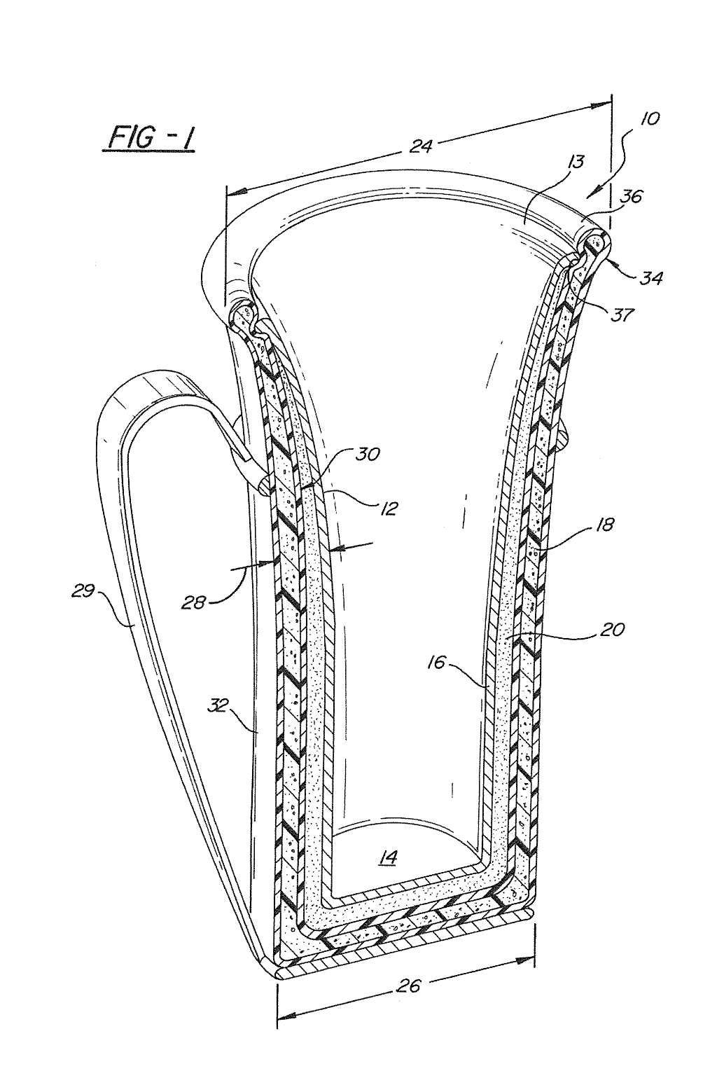

Referring back to FIG. 1, an additional feature of the present invention can be appreciated. The inner vessel 12 is recessed within the outer shell 18. The upper end 13 of the inner vessel 12 is located below the lip 36 of the outer shell 18. This prevents the lips of a consumer from contacting the inner vessel 12 when the consumer drinks from the receptacle 10. Because the inner vessel 12 is highly thermally conductive, the upper end 13 can be uncomfortably warm and therefore it most preferred that it is positioned so that it does not contact the consumer's lips. The amount that the upper end 13 should be recessed varies depending on the shape of the lip 36 and the overall design of the receptacle 10. With the shape illustrated in FIG. 1, it is preferred that the upper end 13 be spaced from the lip 36 by at least ⅛ inch and more preferably by at least ¼ inch. The upper end 13 of the inner vessel 12 seals to the inner surface 30 of the outer shell 18. The seal between the upper end 13 and the inner surface 30 must be sufficient to reliably retain the phase change material in chamber 20. Several sealing methods are available. Currently, it is preferred to form the inner surface 30 with a small recess 37 for the upper end 13 of the inner vessel 12 to snap into. A silicon sealant is applied to the recess 37 before the inner vessel 12 is inserted. A preformed silicon seal offers an alternative. It can be formed to fill a portion of the recess 37.

A plastic version of the receptacle 10 shown in FIG. 1 calls for four parts, three of which are injection molded, and one of which is a stamped aluminum part. The injection molded parts include the outer shell 18 of the receptacle, the handle 29, and an insulating lid. The stamped part is the aluminum inner vessel 12. Once these parts are produced, the remaining assembly can be done in a light manufacturing facility. The receptacle 10 is assembled in a series of four workstations, labeled as receiving, foam insulation injection, general assembly, and finally, packaging and shipping. At the insulation injection workstation, a plastic outer shell is snapped on to an inner mold and a portioned amount of urethane foam is injected into the cavity produced between the outer shell 18 and the inner mold. After this process is completed, the assembly is set aside to cure, generally in a heated area and for a period of two to three hours.

The general assembly station receives warmed, foam lined plastic outer shells 18 from the foaming station, adds the liquid phase change material, applies a bead of adhesive to the sealing point, and snaps the aluminum inner vessel inside the shell 18. This assembly operation must be performed “hot,” that is, at a temperature that exceeds that of the melting point of the phase change material. This assembly temperature varies, but generally does not exceed 150 degree. F. The handle 29 and lid are also added at this station to complete the assembly.

Alternative manufacturing technologies include the use of new expandable polymers such as expandable polypropylene.

The manufacture of a stainless vacuum insulated version of the receptacle 10 varies only in the construction of the outer shell 18. The stainless outer shell 18 is composed of two pieces of stamped stainless steel. One different workstation is required for the fabrication of the vacuum jacketed stainless outer shell 18 from the stamped parts. This workstation is referred to as the welding and evacuation station, and in the four workstation sequence, it replaces the foaming station. As a result, the station sequence for the stainless versions is: receiving, welding and evacuation, assembly, and packaging.

The stainless steel version of the receptacle 10 requires two additional stampings, described as an inner and an outer half. The assembly of the stainless steel outer shell 18 includes pressing the inner and outer halves of this shell together. This operation leaves a seam at the top of the shell 18, and this seam is sealed by a TIG welding process, accomplished with the parts in a rotating holding jig.

Following the welding of the upper edge 34, the shell 18 is inverted, and a small tube attached by welding to the center of a depression in the bottom of the shell 18. This tube serves as the evacuation port. The small tube is connected to a vacuum source in a different section of the workstation, and left to evacuate. Once a sufficient vacuum has been reached, the shell 18 is leak checked. If the shell 18 passes this leak check, the evacuation tube, still under active pumping, is crimped, then welded off. Shells that fail the vacuum check must be inspected and their tops rewelded.

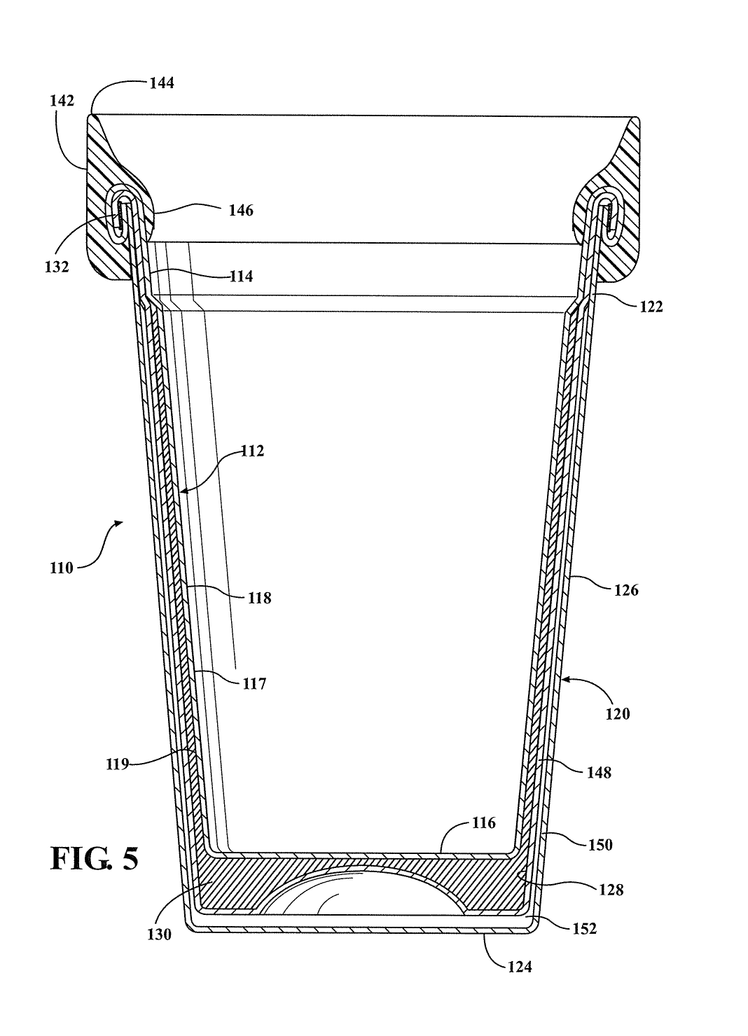

FIG. 5 provides a cross-sectional view of a another embodiment of a liquid receptacle 110. The receptacle has an inner vessel 112 with an open upper end 114, a closed lower end 116, and a side wall 118 extending therebetween. In the illustrated embodiment, the side wall 118 tapers outwardly from the lower end to the upper end. The inner vessel 118 has an inner surface 117 and an opposed outer surface 119.

The receptacle 110 further has an insulated outer shell 120 with an open upper end 122 and a closed lower end 124. A side wall 126 may be said to extend between the closed lower end 124 and open upper end 122. Like the side wall 118, the side wall 126 tapers outwardly. The outer shell 120 has an inner surface 128 that is spaced from the outer surface 119 of the inner vessel so as to define a chamber 130 therebetween. In the illustrated embodiment, the chamber 130 extends between the respective side walls and between the respective closed lower ends of the inner vessel 112 and outer shell 120. A phase change material, also indicated at 130, fills the chamber. The open upper ends 114 and 122 of the inner vessel 112 and outer shell 120, respectively, are interconnected by a hermetic double seam created by double rolling the upper ends and compressing or crimping the double rolled ends so as to form a joined upper end 132.

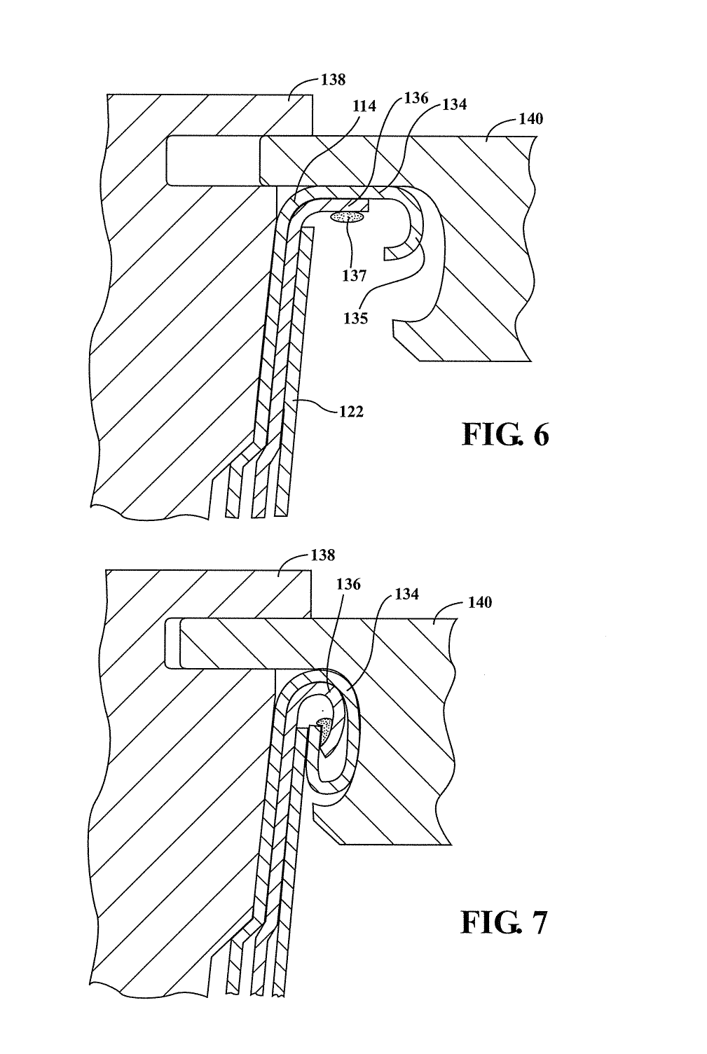

Referring to FIGS. 6 and 7, this double seaming process is illustrated. In FIG. 6, the open upper end 114 of the inner vessel is shown having an outwardly extending flange 134. The flange 134 has a curled portion 135 that extends downwardly and inwardly. The curled portion 135 may be created prior to the double seaming process or as part of the process. The open upper end 122 of the outer shell also has an outwardly extending flange 136. This flange 136 is shorter than and positioned just below the flange 134. The flange 136 is flat and stops short of the curled portion 135. A sealant may be applied as part of the double seaming process. A portion of sealant is shown at 137 on the underside of the flange 136.

A chuck 138 engages the inside of the upper end 114 of the inner vessel and a seam roller 140 moves in and engages the flanges 134 and 136. As the seam roller 140 moves inwardly to the position shown in FIG. 7, the flanges 134 and 136 are double rolled. That is, the flange 134 extends around the outside of the flange 136 as well as back up under it so that there are two “rolls” in the flange 134. The flange 136 is captured between two layers of the flange 134 and a portion of the flange 134 is captured between the flange 136 and the upper end 122 of the outer shell. Following the step shown in FIG. 7, the seam roller 140 may be moved further inwardly so as to compress or crimp the double rolled flanges or a separate crimping step and tool may be used. The finished hermetic double seam is shown at 132 in FIG. 5. As known to those of skill in the art, this illustrative process is similar to the process used to roll and seal the upper ends of metal cans.

Referring again to FIG. 5, some embodiments of the present invention may further include a lip element 142 that interconnects with the double seamed upper end. The lip element is illustrated as having an upper part 144 that defines a drinking lip and a lower part 146 that receives the double seamed upper end. Preferably, the lip element snaps 142 onto the upper end 132 in a semi-permanent fashion. Additional sealing elements or adhesive may be provided, as needed.

As will be clear to those of skill in the art, the insulated outer shell may be formed in a variety of ways. For example, the outer shell may have an inner wall that defines the inner surface and a layer of insulating material that is applied to this inner wall and defines the outer surface of the outer shell. In the illustrated version, the outer shell 120 has a first wall 148 and a second wall 150 that each have closed lower ends and open upper ends. The first and second walls are joined at their open upper ends to form the outer shell. A chamber 152 is defined between the walls. The chamber 152 may be filled with air or other gas, acting as an insulating material. However, preferably, the chamber is filled with an insulating material such as insulating foam, or is evacuated so as to form a vacuum insulated outer shell. Such a vacuum is typically a partial vacuum.

In some versions, the inner and outer walls are both metal. In these versions, the inner vessel is also metal. In versions with an outer shell with two metal walls, the two walls may be joined at their upper ends by welding or the double seaming process may serve to join the upper ends. In further versions, the inner vessel 112 is metal but the walls 148 and 150 of the outer shell 120 are plastic. The plastic walls may be joined at their upper edges by being molded together, glued or melted together, or by other processes. The upper ends of the metal inner vessel and plastic outer shell may be double seamed as illustrated, thereby forming a seal. This process may also interconnect the upper ends of the walls 148 and 150. Additional sealant, adhesive, or melting of the plastic may be used to improve the seal. In an alternative, one of the walls 148 or 150 is plastic while the other is not. In some versions, plastic walls are coated so as to allow them to hold a vacuum and/or resist interaction with the phase change material.

As will be clear to those of skill in the art, the phase change material and insulating material may be provided in a number of ways. In one approach, where the outer shell is vacuum insulated, a port is provided in the outer wall 150. After the walls of the outer shell are interconnected, the cavity 152 is at least partially evacuated and the port is sealed. In a version where an insulating material is provided between the walls 148 and 150, the insulating material may be added prior to inserting the inner wall 148 into the outer wall 150. The same may be done with the phase change material. It may be added to the inside of the insulated outer shell prior to inserting the inner vessel into the outer shell 120. One example of an assembly method for a liquid receptacle in accordance with the present invention is to first form the insulated outer shell having an open upper end with an outwardly extending flange. An inner vessel is also formed with an open upper end with an outwardly extending flange. This inner vessel is formed of metal. A phase change material is added to the inside of the insulated outer shell and then the inner vessel is inserted down into the outer shell causing at least some of the phase change material to be displaced up into the chamber between the side walls. The phase change material and the outer shell and inner vessel are warmed to maintain the phase change material in a liquid state during the process. A chuck is then inserted into the inside of the inner vessel and a seam roller rolls the flange on the inner vessel around the flange of the outer shell to form a double rolled connection. This connection is compressed or crimped, which is defined as compressing the metal flange of the inner vessel sufficiently to produce the desired mechanical interconnection. This manner of connection and sealing is commonly described in the industry which stores food in metal cans as a “hermetic double seam.” Other approaches to interconnecting the inner vessel and outer shell may also be used.

The inner vessel 112 is preferably formed of a material with good heat transfer properties. It is desirable to transfer heat from liquid contained in the inner vessel 112 into the phase change material 130 rapidly so as to rapidly lower the temperature of the liquid to the desired range. One preferred material is aluminum. The aluminum may be coated or anodized on its inner surface to improve its appearance, durability and/or food contact properties. Other materials may be used. For example, other metals, including stainless steel, may be used for the inner vessel. While metals such as stainless steel have a lower thermal conductivity than aluminum, the thermal conductivity is sufficient for some applications. According to a further embodiment, the inner vessel may be at least partially formed of a thermally conductive plastic, such as thermally conductive HDPE. While this plastic also has a thermal conductivity lower than aluminum, and also lower than most metals, the thermal conductivity may be sufficient for some applications.

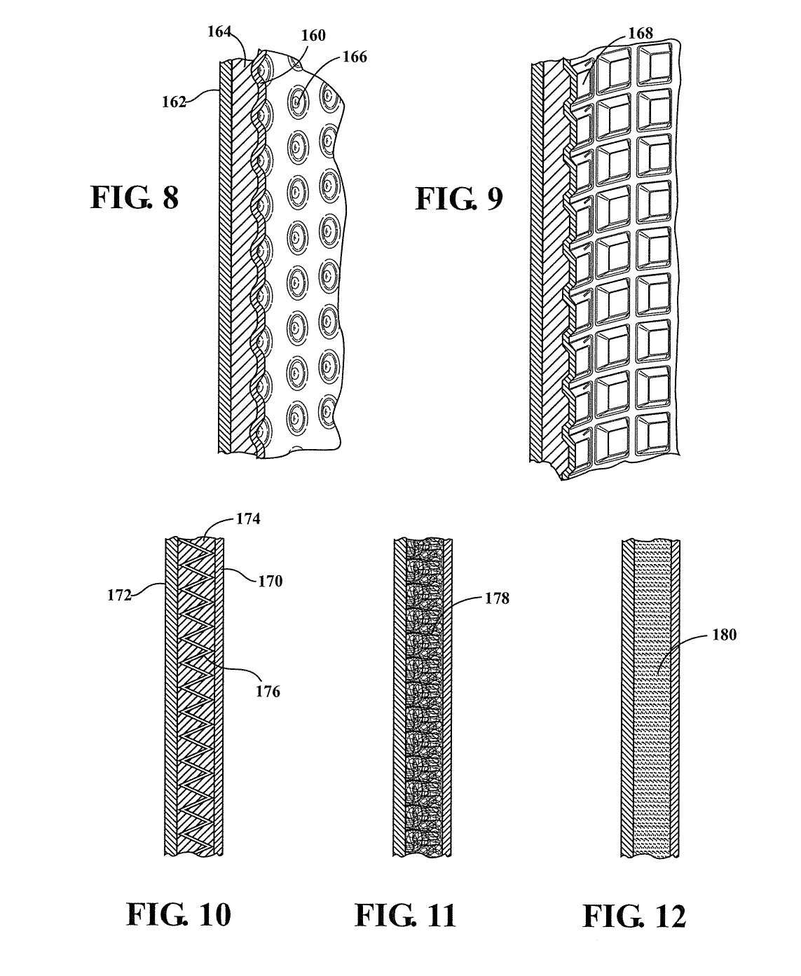

As known to those of skill in the art, it is desirable to use a material for the inner vessel that quickly conducts thermal energy from the liquid to the phase change material. The present invention further provides approaches for improving the transfer of energy from the liquid to the phase change material, other than the use of more thermally conductive materials. Referring to FIG. 8, a portion of a liquid receptacle in accordance with the present invention is shown. A wall of an inner vessel is shown at 160. Another wall is shown at 162, spaced from the inner wall 160. A chamber 164 is defined between the two walls. This drawing is generic to any of the embodiments of the present invention, as well as to other designs. The wall 162 may be considered to be the inner wall of an insulated outer shell. As shown, the inner wall 160 has a plurality of indentations 166 defined therein. These indentations distort the wall 160 thereby increasing the surface area both on the inner surface and outer surface. The wall 160 may be said to have indentations in the inner surface and corresponding protrusions in the outer surface. In the illustrated embodiment, the wall thickness is substantially uniform. Alternatively, the wall thickness may vary somewhat, due to the process of adding the indentations. The indentations may take any of a variety of forms. The configuration may also be reversed, with the indentations being formed in the outer surface and corresponding protrusions on the inner surface, or protrusions and indentations may be mixed on each surface.

In FIG. 8, the indentations take the form of a plurality of dimples uniformly distributed on the wall 160. Alternatively, the dimples may be distributed differently than shown, may have different shapes than shown, or may be spaced apart differently than shown. In one example, the surface may have more of the appearance of the surface of a golf ball. FIG. 9 illustrates an alternative version wherein the indentations extend from the outer surface to the inner surface in a waffle-like grid with each indentation being generally square. This forms protrusions 168 on the inner surface. Further alternatives are indentations that are in the form of lines or grooves such as forming a grid. As will be clear to those of skill in the art, these various approaches substantially increase the surface area of both the inner and outer surfaces.

One challenge with phase change materials is that as heat is transferred through the inner wall into the phase change material, the phase change material closest to the wall melts or changes phase. Phase change materials often have poor thermal conductivity, and further the thermal conductivity is often lower in a phase change material in a liquid state than it is in that same phase change material in a solid state. Phase change material farther from the wall may not melt and the rate of heat transfer into the chamber containing the phase change material may drop off Put another way, it is often a challenge to transfer the heat into the phase change material that is farther from the wall.

According to an additional aspect of the present invention, approaches are provided for improving the transfer of heat across the chamber by augmenting thermal conductivity and/or heat flow properties through design and materials to enhance thermal performance. Referring to FIG. 10, an inner wall is shown at 170, an outer wall is shown at 172, and a chamber 174 is defined therebetween. The chamber 174 is filled with a phase change material. Additionally, a metal heat transfer element is disposed in the chamber 174. The metal heat transfer element may take a variety of forms. In FIG. 10, a folded fin heat sink 176 is provided. It is a very thin sheet of highly conductive metal that is folded into a zigzag pattern and is positioned so as to extend between the walls 170 and 172. When used with a thermal receptacle as discussed herein, one approach would be to insert the heat sink 176 between the concentric walls of the inner vessel and outer shell such that the zigzag pattern would be seen in a horizontal cross section. FIG. 10 merely illustrates a pair of parallel walls, whereas in use the walls would likely be curved.

FIG. 11 illustrates an alternative version in which the metal heat transfer element is a body of aluminum wool 178. Aluminum wool consists of a large number of very thin strands of aluminum bunched together similar to steel wool. FIG. 12 illustrates yet another approach in which a metal mesh 180 is provided between the walls. Alternatively, FIG. 8 may be considered to illustrate a plurality of metal or graphite particles dispersed in the phase change material. Each of these approaches may improve the transfer of heat from the phase change material close to the inner wall to the phase change material that is farther from the inner wall.

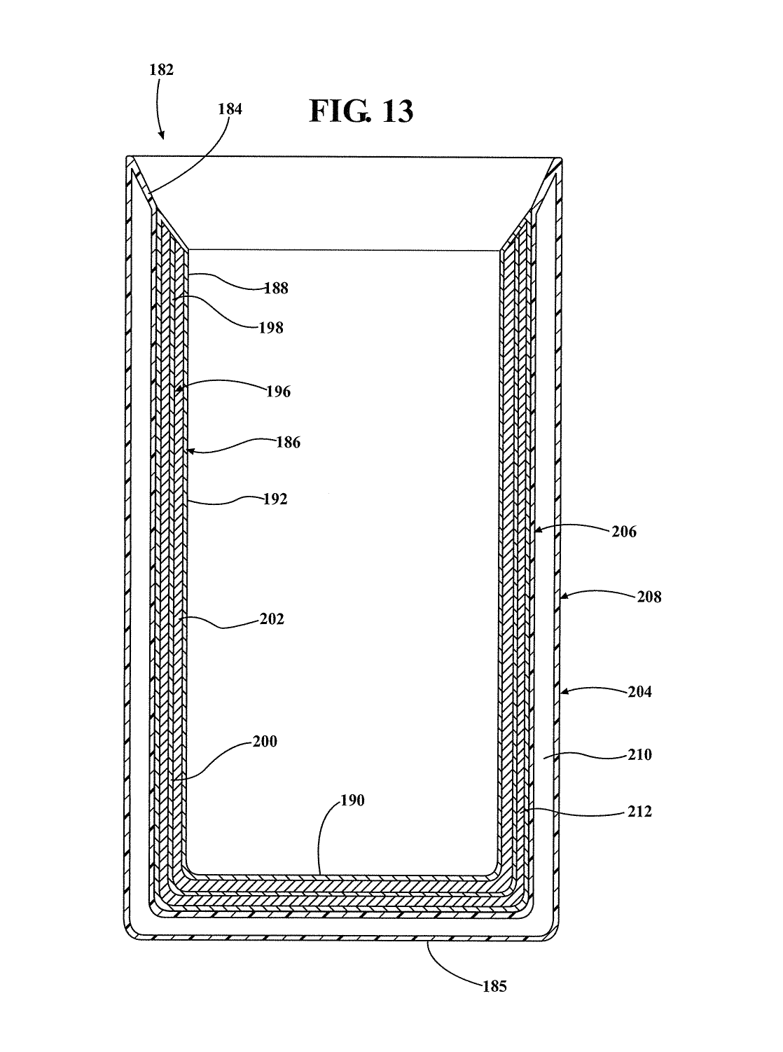

Referring now to FIG. 13, a further embodiment of the present invention will be discussed. FIG. 13 illustrates a liquid receptacle 182 with a drinking lip 184 at the uppermost end and a base 185 at the lowermost end. The receptacle 182 includes an inner vessel 186 with an open upper end 188 and a closed lower end 190. A side wall 192 extends between the lower end 190 and upper end 188. A first intermediate wall 196 has an upper end 198 and a lower end 200. The first intermediate wall 196 surrounds the inner vessel 186 and is at least partially spaced therefrom so as to define a first chamber 202 therebetween. An insulated outer shell 204 is formed by a second intermediate wall 206 and an outer wall 208. The outer wall 208 is at least partially spaced from the second intermediate wall 206 so as to define an insulation chamber 210 therebetween. The second intermediate wall 206 surrounds the first intermediate wall 196 and is spaced therefrom so as to define a second chamber 212 therebetween.

In the illustrated embodiment, the second intermediate wall is shown as a two layer wall, such as two layers of metal. This represents a version in which an inner assembly is press fit into an outer assembly to form the receptacle 182. Alternatively, the second intermediate wall is a single layer.

In the illustrated embodiment, the inner vessel 186, first intermediate wall 196, second intermediate wall 206, and outer wall 208 all have a similar shape and are nested within each other so as to form a four-wall vessel. In the illustrated embodiment, the chambers between the walls extend between the sides as well as across the bottom of the vessel. The upper ends of the inner vessel and the walls are interconnected at the upper lip 184. In the illustrated embodiment, the first chamber 202 has a first phase change material disposed therein, while the second chamber 212 has a second phase change material disposed therein. The phase change materials may be the same or may be different materials and/or have different phase change temperatures. In one example, the phase change temperature of the second phase change material is slightly higher than the phase change temperature of the first phase change material. The insulation chamber 210 may have a vacuum or an insulating material disposed therein. In the illustrated embodiment, this chamber is shown as empty, which may correspond to a vacuum or to air. In alternative embodiments, the outer shell may be formed in other ways, not having two separate walls. In this case, the inner surface of the insulated outer shell forms the outer wall of the second chamber 212. In further alternatives, the second chamber may not have a second phase change material therein. In yet further versions, additional walls are provided so as to provide additional chambers, such as a five or six wall receptacle with four or five chambers.

In versions having two phase change materials, the first phase change material in the first chamber 202 may very quickly change phases, or melt, as heat is transferred through the wall of the inner vessel 192 into the phase change material. Heat may then be transferred into the second chamber 212 causing the second phase change material to begin to melt. However, by choosing the phase change temperatures of the phase change materials and the construction materials of the various walls of the device, the heat flow can preferentially be directed to flow back towards the liquid rather than outwardly to the insulated outer shell. As compared to a receptacle having a single phase change material in a single chamber, the illustrated version may have a lower quantity of phase change material in the first chamber than the total used in a single phase change material version. As such, the entirety of the phase change material in the first chamber melts more quickly, and then further heat transfer may occur to the second chamber.

In a further version, having multiple chambers, phase change material may be provided in a first chamber and a third chamber with a second chamber being disposed between the first and third chamber. A heat transfer material, such as water, oil or other liquids, may then be provided in the second chamber.

As will be clear to those of skill in the art, a receptacle with four or more walls may be formed in various ways. In one approach, the upper portion of the vessel is molded out of plastic with concentric walls. A bottom cap is then attached, such as by spin welding, to define the bottoms of each wall. The different chambers then may be filled through ports. The embodiment illustrated in FIG. 13 may be referred to as a four-wall receptacle or, where the insulated outer shell is not formed with two walls, it may be referred to as a two chamber receptacle. Other numbers of walls may be formed. In another approach, the receptacle is formed using metal injection molding, allowing the creation of accurate parts.

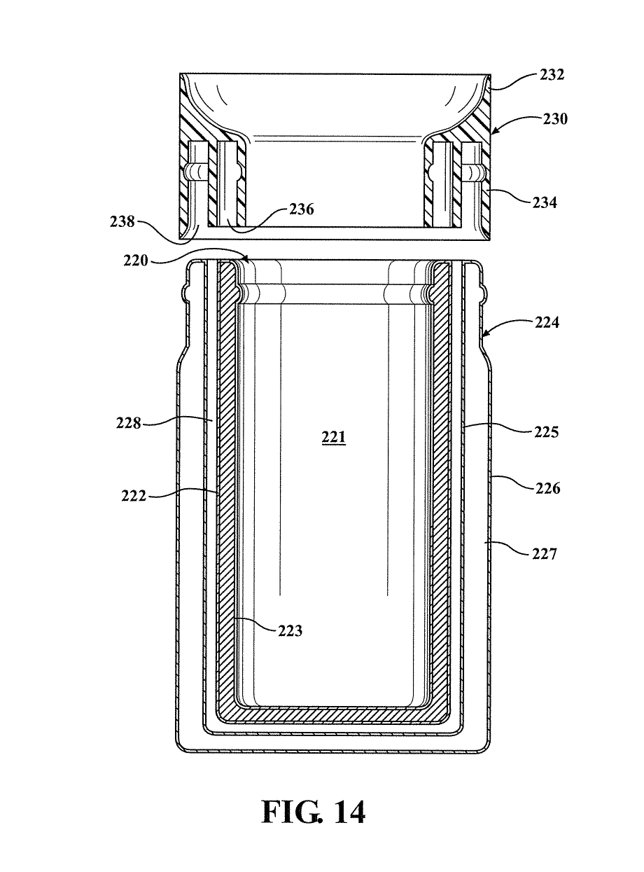

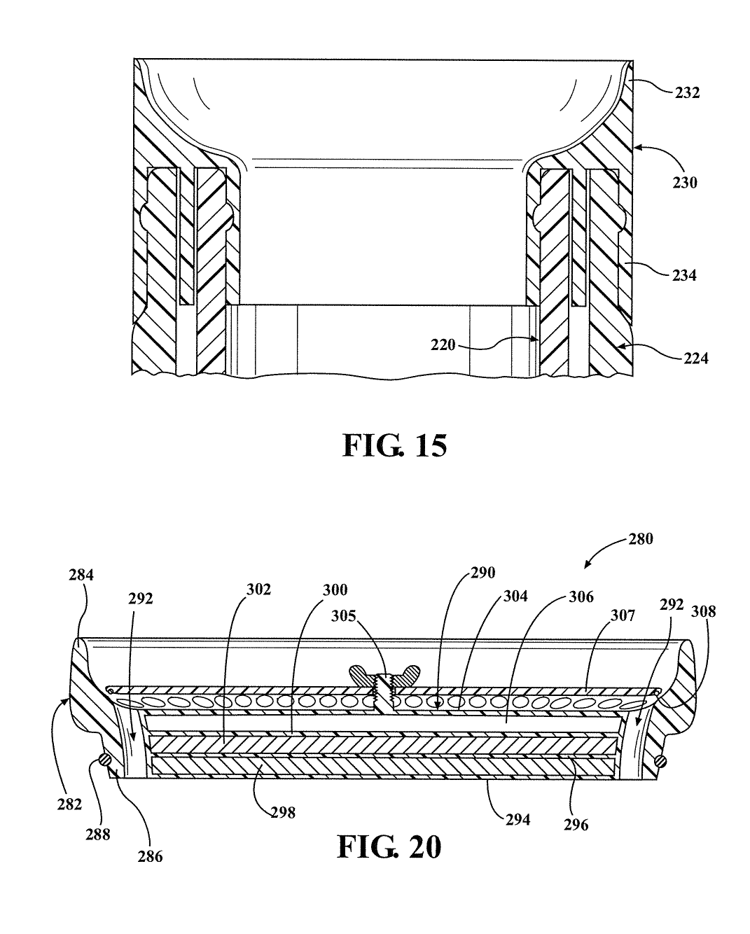

Referring now to FIGS. 14 and 15, a different approach to forming a two-chamber or four-wall receptacle will be discussed. In this version, an inner two wall cup 220 is received inside of an outer two wall cup 224. Each of these two wall cups may be formed in a variety of ways. In one approach, an inner and outer wall are interconnected in the same way as discussed for FIGS. 5-7, wherein an upper edge of each wall is interconnected by double seaming. The two wall cup may also be formed in any of the ways currently used to form vacuum insulated vessels. The two wall cup may also be formed by molding, including plastic or metal injection molding.

In the illustrated embodiment, the inner two wall cup 220 may be said to have an inner vessel 221 that is surrounded by a first intermediate wall 222. The inner vessel and intermediate wall 222 are interconnected at their upper ends and are spaced apart so as to define a chamber 223 defined therebetween. This is the first chamber, corresponding to the first chamber in FIG. 13. A second intermediate wall 225 and an outer wall 226 form the outer two wall cup 224. The walls are spaced apart so as to define an insulation chamber 227, which is filled with an insulating material or is evacuated. The second intermediate wall 225 is spaced from the first intermediate wall 222 when the inner two wall cup 220 is received in the outer two wall cup 224. This defines the second chamber 228. The inner two wall cup 220 and outer two wall cup 224 may be interconnected by double seaming the upper ends. However, in the illustrated embodiment, a lip element 230 interconnects the two cups. The lip element 230 has an upper part 232 that defines a drinking lip and a lower part 234 that receives the upper ends of the inner two wall cup and the outer two wall cup. The lower part 234 has a pair of concentric grooves 236 and 238 and the inner and outer cups preferably snap into these grooves. Sealing elements or materials may be provided for improving the seal. Alternatively, the inner and outer cups may thread into the lip element 230. FIG. 14 shows the inner and outer cup before being assembled into the lip element 230 and FIG. 15 shows the upper portion after the pieces are assembled.

This approach may allow inner two wall cups filled with different phase change materials to be interconnected with outer two wall cups to form receptacles with different performance characteristics. In one approach, a plurality of inner two wall cups are produced with different phase change materials. Outer two wall cups are also produced with phase change materials in the chamber. The inner two wall cup can be received in the outer two wall cup, with a heat transfer material in the chamber 228 therebetween, to transfer heat from the inner chamber to the outermost chamber. The heat transfer material may be a liquid such as water or oil. The outer two wall cup may have an additional layer of insulation thereon, or may have another chamber and be a three wall cup. In one option, the outer two wall cup has a phase change material in the chamber between its walls, and the phase change materials are chosen such that heat preferentially flows back to the inner vessel.

An approach similar to that shown in FIGS. 14 and 15 may be used to provide more than four walls. For example, a six wall receptacle may be formed by nesting three two wall cups and interconnecting them using a lip element.

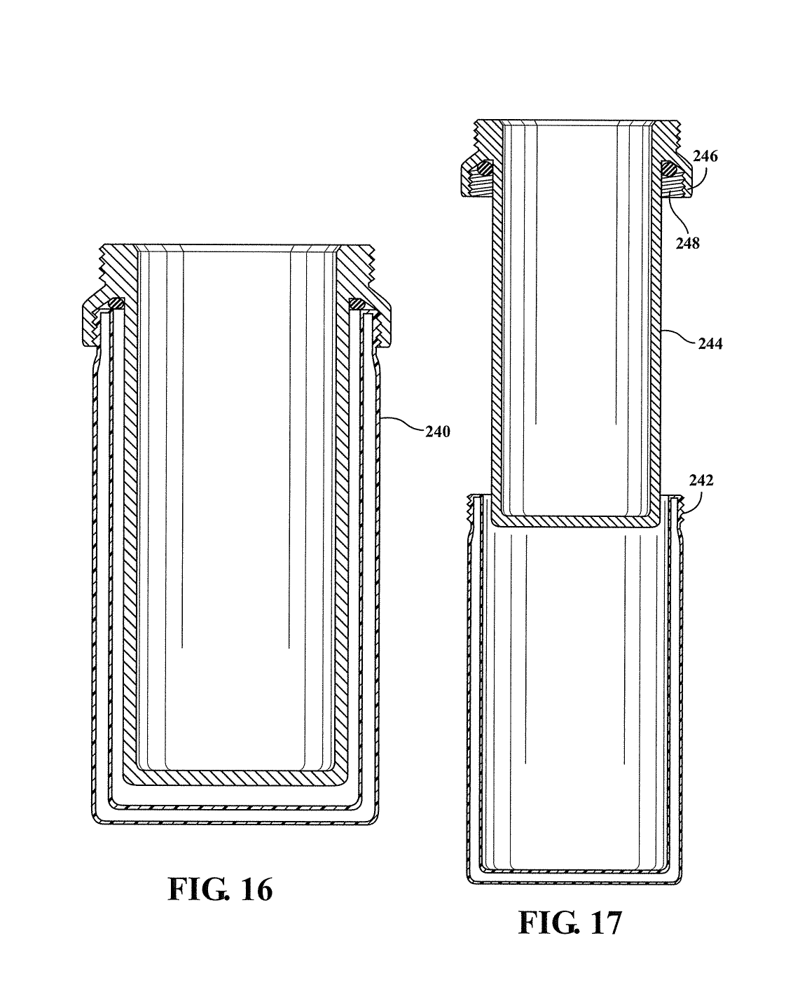

Referring now to FIGS. 16 and 17, an alternative approach is illustrated. In this approach, an outer two wall cup 240 has threads 242 defined on the outer surface of its upper end. An inner two wall cup 244 has a receiving portion 246 near its upper edge with threads 248 on the inside of the receiving area. These threads 248 cooperate with the threads 242 so as to interconnect the inner cup 244 with the outer cup 240. The inner cup 244 is also shown as having threads on an outer surface near its upper edge for threadingly connecting a lid or a lip element. A seal may be provided above the threads 248 in the receiving portion 246. This approach could allow different two wall cups to be interconnected to provide different performance characteristics. As one example, the inner two wall cup could have one phase change material therein and the outer two wall cup could have another. A heat transfer liquid could fill the chamber between the two cups.

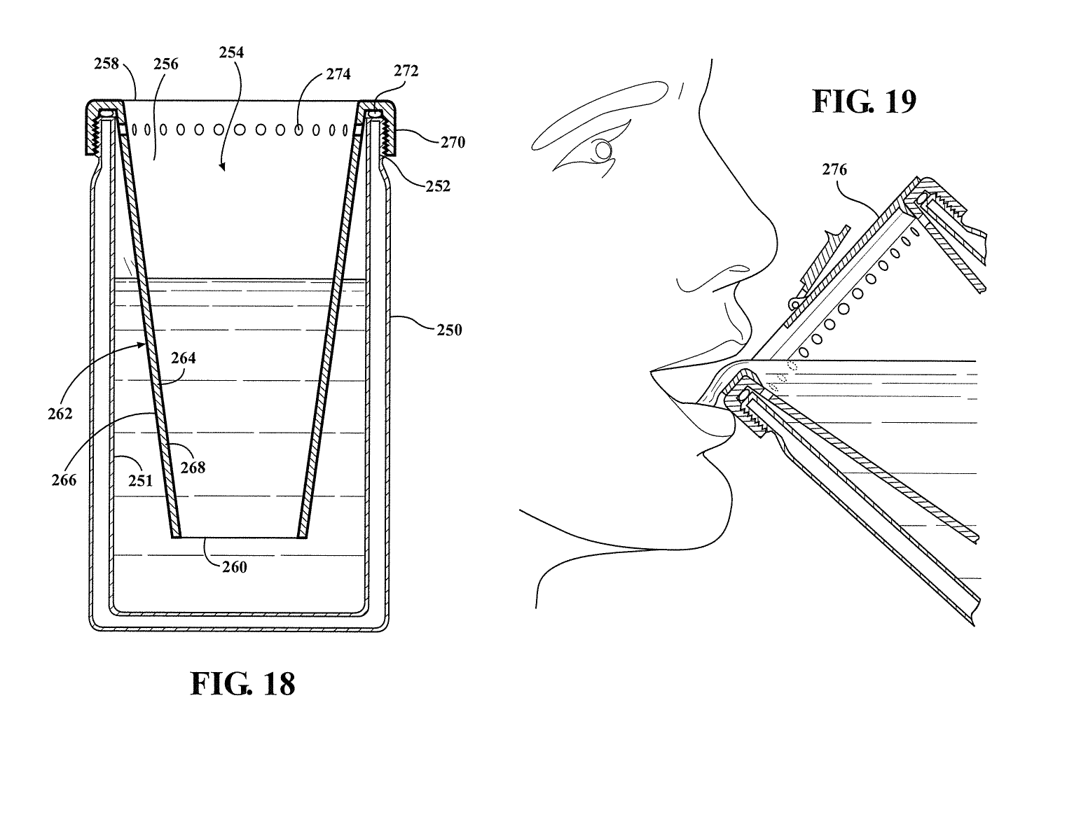

Referring now to FIGS. 18 and 19, the present invention also provides an apparatus for providing the benefits of phase change material to an insulated cup such as the many currently available insulated mugs. Such an insulated cup is shown at 250 in FIG. 18. The illustrated version is a double wall vacuum insulated cup with a threaded upper end 252. This is merely exemplary of the wide variety of insulated cups available, some of which have upper drinking lips and others have detachable lips or lids. The illustrated cup 250 is of the type that would have a separate lid or lip element that forms the drinking lip. The present invention provides a phase change apparatus 254 designed to interconnect with the insulated cup 250. The phase change apparatus includes a generally tubular housing 256 with an open upper end 258 and an open lower end 260. In the illustrated embodiment, the generally tubular housing 256 is tapered such that the open lower end 260 is substantially smaller than the open upper end 258. A side wall 262 extends between the upper end 258 and lower end 260 and has an inner surface 264 facing inwardly and an opposed outer surface 266 facing outwardly. A chamber 268 is defined between the inner surface 264 and outer surface 266. A phase change material is disposed in this chamber 268 for regeneratively absorbing thermal energy from a liquid in the insulated cup 250 and then releasing the thermal energy back to the liquid to maintain the temperature of the liquid.

As shown in this embodiment, the outer surface 266 of the side wall 262 is spaced inwardly from the inner surface 251 of the insulated cup 250 such that liquid fills the space between the surfaces as well as inside the tubular housing. This provides a large surface area for transferring heat between the liquid and the phase change material. The upper end 258 of the tubular housing is configured to engage the upper end of the insulated cup, as shown. In this embodiment, the upper end 258 includes a receiver 270 that threads onto the threads of the upper end 252 of the cup 250. A sealing element 272 is provided for sealing between the generally tubular housing and the cup 250. A plurality of passages 274 are defined between the inner surface 264 and outer surface 266 of the generally tubular housing near the upper end of the housing. As best shown in FIG. 19, these openings allow liquid disposed between the inner surface 251 of the insulated cup and the outer surface 266 of the tubular housing to flow therethrough and to be consumed. FIG. 19 also illustrates a snap-on lid 276 that may form part of the drinking lip of the cup. The tubular housing is preferably formed of a material with good thermal conductivity. However, the upper end may be made of or covered with a less thermally conductive material, such as plastic.

FIG. 20 illustrates a drinking lid 280 that may form an aspect of the present invention, and may be used with other aspects described herein. The lid has a perimeter 282 with a drinking lip 284 and a lower portion 286. The lower portion 286 may be configured to be received in or on the upper end of a cup or mug. In the illustrated embodiment, the lower portion has an outer surface designed to fit into the upper end of a mug or cup, with a sealing element 288 for providing a good seal. Any configuration may be used, including threaded, snap-on and press-fit. The lid 280 has a central portion 290 that is spaced inwardly from the perimeter 282 so as to define a plurality of drinking passages adjacent the perimeter. The central portion 290 has a bottom wall that faces the inside of the mug or cup. A first intermediate wall 296 is spaced upwardly from the bottom wall so as to define a first chamber 298 therebetween. In this embodiment, the chamber 298 is filled with a first phase change material. In the illustrated embodiment, the central portion 290 further has a second intermediate wall 300 spaced upwardly from the first intermediate wall 296 so as to define a second chamber 202 therebetween. A second phase change material is disposed in the second chamber 302. A top wall 304 is spaced above the second intermediate wall 300 so as to define an insulation chamber 306 therebetween. The insulation chamber may be evacuated or filled with an insulating material. The lid 280 helps to maintain the temperature of a beverage in the cup but may also help to modulate the temperature of liquid that flows through the passages 292. Alternative versions may include only a single chamber for phase change material, with or without insulation.

FIG. 20 also shows an optional sealing cap 307 for the lid 290. In this version, a center post 305 extends up from the top wall 304. The post 305 may be threaded. The cap 307 fits onto this post and extends outwardly to a perimeter edge with a perimeter seal 308. As shown, the perimeter and seal 308 is located outboard of the passages 292. As such, if the cap 307 is tightened against the lid 290, the seal 308 seals the top of the lid. Tightening of the cap may be accomplished in several ways. A thumb screw is illustrated, which may form part of the cap or be separate. The entire cap may rotate to tighten. Other approaches are also possible. The seal 308 may take different forms. For example, a wider seal may be provided and positioned so as to seal the openings 292 themselves, rather than the entire area.

A variety of phase change materials may be used with embodiments of the present invention. In some embodiments, a preferred phase change material is palmitic acid. The phase change temperature of the phase change material may be selected to provide a desired drinking temperature. This temperature may be different for different applications, such as providing a higher temperature phase change material for users that like to drink beverages very hot and a lower temperature phase change material for those that prefer beverages at a lower temperature. In embodiments using two phase change materials, the phase change material in the inner chamber may be stearic acid or palmitic acid. Preferably, any phase change materials selected are non-toxic, food-grade materials that are also not corrosive or reactive to the metals or materials being used for containment of such phase change materials. In some versions, the phase change material has a phase change temperature in the range of 61 to 68 degrees Celsius.

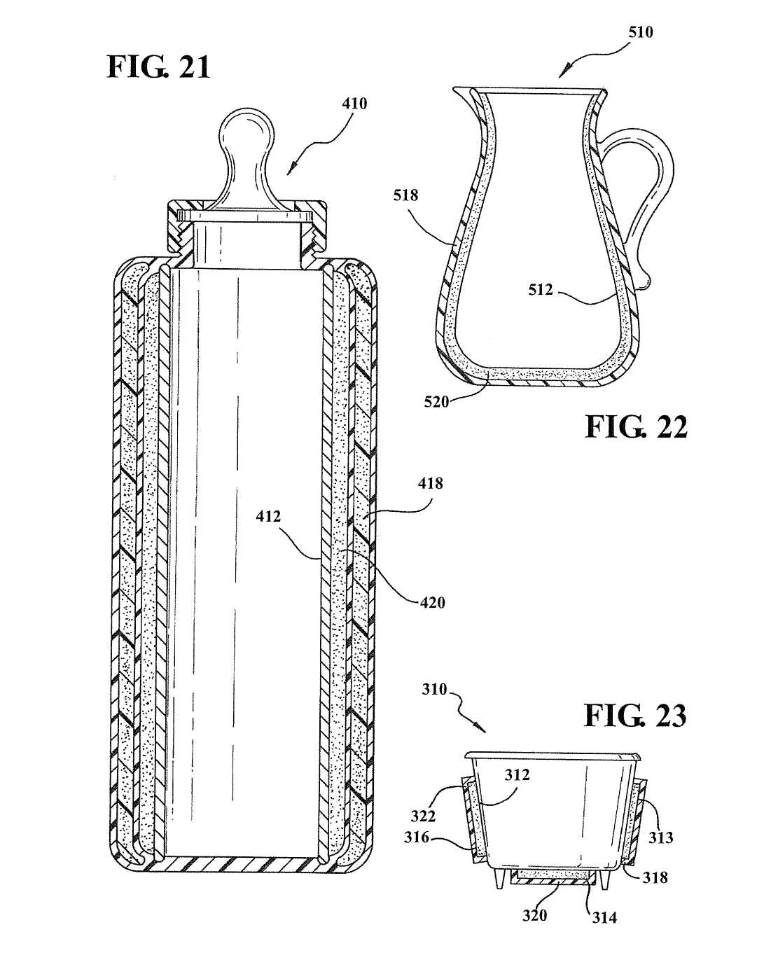

A baby bottle 410 incorporating a phase change material is another alternative embodiment of the present invention as shown in FIG. 21. The baby bottle 410 includes a thermally conductive inner vessel 412 surrounded by an insulated outer shell 418. The outer shell 418 is spaced from the inner vessel 412 so as to form a chamber 420 which is at least partially filled with a phase change material. The acceptable temperature for liquid consumed by infants is significantly lower than the temperature desired by adults so a phase change material with a lower phase change temperature is used. The outer shell 418 can be plastic with a foam insulation layer or vacuum insulated stainless steel. It is desirable to minimize the weight of a baby bottle to allow an infant to support its weight unaided. Therefore, a lightweight plastic outer shell 418 with foam insulation is most preferred. The shell 418 may also incorporate a handle or other gripping means to allow an infant to more easily grasp the baby bottle 410. For maximum benefit from the phase change material, the infant beverage should be added to the bottle at a temperature above the warm range for infants so that excess thermal energy is absorbed by the phase change material. After a short period, the phase change material will have absorbed the excess thermal energy thus lowering the temperature of the beverage into the warm range for an infant. The excess thermal energy will serve to maintain the temperature of the beverage for an extended period. This is desirable if the infant is fussy and refuses to drink the entire contents of the bottle immediately. The temperature stabilizing effect of the phase change material has the additional benefit that parents will not have to worry about checking to see if the beverage is too hot. The bottle holds sufficient phase change material that a beverage could be added at boiling temperature. The bottle will cool the beverage to the acceptable range within a short period. Therefore, parents can be confident that as long as they wait a proscribed period, the beverage will be safe. The bottle may also incorporate a timing device or a temperature indicator to provide the parents with additional information.

In FIG. 22, a further alternative embodiment, a carafe incorporating phase change material, is generally shown at 510. The carafe 510 includes a thermally conductive inner vessel 512 surrounded by an insulated outer shell 518. The shell 518 is spaced from the inner vessel 512 so as to form a chamber 520 which is at least partially filled with a phase change material. Since the carafe 510 will be used to hold hot beverages for pouring into mugs or cups, it is desirable to hold the beverage at a higher temperature than the maximum acceptable drinking temperature. When the beverage is poured from the carafe 510 into a mug, the mug will cool the beverage. Therefore, the pouring temperature should be higher than the desired drinking temperature. The carafe 510 will differ from the drinking receptacle 10 in that the carafe 510 will require significantly more phase change material to adequately absorb and store the thermal energy of the increased mass of hot beverage. Also, a phase change material with a higher phase change temperature is preferred.

In FIG. 23, a third alternative embodiment, a bathtub incorporating phase change material, is generally shown at 310. The bathtub 310 includes a thermally conductive vessel 312. Attached to the exterior of the vessel 312 are boxes 313, 314, 316 which are at least partially filled with phase change material. Surrounding the boxes 313, 314, 316 are insulating layers 318, 320, 322. When hot bathing water is added to the bathtub 310, the phase change material absorbs thermal energy conducted into the boxes 313, 314, 316 from the bathing water. The bathing water quickly cools to an acceptable bathing temperature and then the phase change material starts conducting thermal energy back into the bathing water thereby maintaining its temperature. The boxes 313, 314, 316 are removably attached to the exterior of the vessel 312 so that boxes with different phase change materials can be substituted. This allows for changes in the sustained temperature of the bathing water as may be desirable when adults and children use the same bathtub. For example, when someone plans to use the tub, they would check to see what boxes 313, 314, 316 are connected. If a child is going to use the tub, the low temperature version of the boxes 313, 314, 316 should be connected. After confirming that the low temperature boxes are connected, an adult can fill the tub with hot water for the child. After a set period of time has passed, the temperature of the water in the tub will be acceptable and safe for the child. If later, the adult wishes to use the same tub for a higher temperature soak, they would change the boxes 313, 314, 316 to the higher temperature version, drain the tub if necessary, and refill the tub with hot water. It should be noted that the tub would require refilling with hot water if the boxes 313, 314, 316 were changed. The new hot water would then melt the phase change material in the new boxes 313, 314, 316 for the new bath. If the boxes 313, 314, 316 were changed without changing the water in the tub, the water in the tub would not have sufficient thermal energy to melt the phase change material in the boxes 313, 314, 316. Therefore, the phase change material could not provide the temperature maintenance function that it would ordinarily provide if it were melted by the excess thermal energy of fresh hot water.

Any of the configurations and elements described herein may be used with other configurations and elements herein in any combination.

As will be clear to those of skill in the art, the herein described embodiments of the present invention may be altered in various ways without departing from the scope or teaching of the present invention. It is the following claims, including all equivalents, which define the scope of the invention.

We claim:

1. A liquid receptacle for rapidly lowering the temperature of a liquid contained therein to a warm range suitable for human contact and maintaining the liquid in the warm range for an extended period of time, the receptacle having a drinking lip at the uppermost end, the receptacle comprising:
an inner vessel having an open upper end and closed lower end and a wall connecting the upper end and the lower end;
the inner vessel having an inner surface with plurality of indentations or protrusions defined thereon and an outer surface with a plurality of corresponding protrusions or indentations defined thereon such that the effective surface area of the inner and outer surfaces is increased and heat transfer through the wall of the inner vessel is increased;
an insulated outer shell spaced from the inner vessel defining an interstitial chamber therebetween, the insulated outer shell having an open upper end and a closed lower end; and
a phase change material disposed within said chamber for regeneratively absorbing thermal energy from the liquid and then releasing the thermal energy to the liquid to maintain the temperature of the liquid.

2. A liquid receptacle according to claim 1 wherein said outer shell comprises an inner layer and an outer layer with an evacuated void therebetween for vacuum insulating said outer shell.

3. A liquid receptacle according to claim 1 wherein said outer shell comprises a layer of insulating foam.

4. A liquid receptacle in accordance with claim 1, wherein:
the insulated outer shell comprises a second intermediate wall surrounding the first intermediate wall and an outer wall surrounding the second intermediate wall, the outer wall being at least partially spaced from the second intermediate wall so as to define an insulation chamber therebetween, the insulation chamber having a partial vacuum or an insulating material disposed therein.

5. A liquid receptacle for rapidly lowering the temperature of a liquid contained therein to a warm range suitable for human contact and maintaining the liquid in the warm range for an extended period of time, the receptacle having a drinking lip at the uppermost end and a base at the lowermost end, the receptacle comprising:
an inner vessel for holding a liquid, the inner vessel having an open upper end and a closed lower end with a side wall extending therebetween;
a first intermediate wall having an upper end and a lower end, the first intermediate wall surrounding the inner vessel and at least partially spaced therefrom so as to define a first chamber therebetween;
an insulated outer shell having an upper end and a lower end, the insulated outer shell surrounding the first intermediate wall and at least partially spaced therefrom so as to define a second chamber therebetween; and
a first phase change material disposed within the first chamber for regeneratively absorbing thermal energy from the liquid and then releasing the thermal energy to the liquid to maintain the temperature of the liquid.

6. A liquid receptacle in accordance with claim 5, further comprising:
a second phase change material disposed within the second chamber, the second phase change material having a phase change temperature different than the first phase change material.

7. A liquid receptacle in accordance with claim 5, wherein:
the insulated outer shell comprises a second intermediate wall surrounding the first intermediate wall and an outer wall surrounding the second intermediate wall, the outer wall being at least partially spaced from the second intermediate wall so as to define an insulation chamber therebetween, the insulation chamber having a partial vacuum or an insulating material disposed therein.

8. A liquid receptacle in accordance with claim 7, wherein:
the outer wall and the second intermediate wall comprise an outer two wall cup having a closed lower end and an open upper end, the upper end of the outer wall and the upper end of the second intermediate wall being interconnected to define the open upper end of the outer two wall cup; and
the inner vessel and the first intermediate wall comprise an inner two wall cup having a closed lower end and an open upper end, the upper end of the inner vessel and the upper end of the first intermediate wall being interconnected to define the open upper end of the inner two wall cup;
wherein the inner two wall cup is received inside the outer two wall cup to form the liquid receptacle.

9. A liquid receptacle in accordance with claim 5, wherein:
the first intermediate wall has a closed bottom spaced from the closed bottom of the inner vessel;
the insulated outer shell has a closed bottom spaced from the closed bottom of the first intermediate wall;
the inner vessel, first intermediate wall and insulated outer shell being interconnected adjacent the upper ends of the vessel, wall and shell.

10. A liquid receptacle in accordance with claim 5, further comprising:
a lip element having an upper part defining the drinking lip of the liquid receptacle and a lower part interconnected with the upper ends of the inner vessel, first intermediate wall and insulated outer shell.

11. A liquid receptacle in accordance with claim 5, further comprising:
a metal heat transfer element disposed in the first chamber and partially filling the chamber, the metal heat transfer element selected from the group consisting of a body of aluminum wool, a folded fin heat sink, and a mesh of metal or other thermally conductive material.

12. A liquid receptacle for rapidly lowering the temperature of a liquid contained therein to a warm range suitable for human contact and maintaining the liquid in the warm range for an extended period of time, the receptacle having a drinking lip at the uppermost end and a base at the lowermost end, the receptacle comprising:
an inner vessel for holding a liquid, the inner vessel having an open upper end and a closed lower end with a side wall extending therebetween, the inner vessel having an inner surface and an outer surface, the inner vessel being formed of metal;
an insulated outer shell having an open upper end and a closed lower end, the outer shell having an inner surface;
the open upper ends of the inner vessel and the outer shell being interconnected by double seaming the upper end of the inner vessel with the upper end of the outer shell and crimping the double rolled upper ends to form a joined upper end;
a chamber defined between the inner surface of the outer shell and the outer surface of the inner vessel; and
a phase change material disposed within the chamber for regeneratively absorbing thermal energy from the liquid and then releasing the thermal energy to the liquid to maintain the temperature of the liquid.

13. A liquid receptacle in accordance with claim 12, further comprising:
a lip element having an upper part defining the drinking lip and a lower part receiving the joined upper end of the inner vessel and outer shell.

14. A liquid receptacle in accordance with claim 12, wherein:
the insulated outer shell comprises a first and a second wall each having an open upper end and a closed lower end, the first and second walls being joined at the open upper ends to form the outer shell;
an insulation chamber being defined between the first and second walls, the insulation chamber having a vacuum or an insulating material disposed therein.

15. A liquid receptacle in accordance with claim 14, wherein:
the first and second walls are formed of plastic.

16. A liquid receptacle in accordance with claim 12, wherein:
the inner vessel has an inner surface with plurality of indentations defined therein and an outer surface with a plurality of corresponding protrusions defined thereon such that the effective surface area of the inner and outer surfaces is increased;
whereby heat transfer through the inner vessel is increased.

17. A liquid receptacle in accordance with claim 12, further comprising:
a metal heat transfer element disposed in the chamber and partially filling the chamber, the metal heat transfer element selected from the group consisting of a body of aluminum wool, a folded fin heat sink, and a mesh of metal or other thermally conductive material.
